(19) United States
(12) Patent Application Publication
(10) Pub. No.: US 2023/0035803 A1
(43) Pub. Date: Feb. 2, 2023

(54) MILLIMETER WAVE RADAR DEVICE

(71) Applicant: Mitsubishi Electric Corporation, Tokyo (JP)

(72) Inventor: Takashi OHARA, Tokyo (JP)

(73) Assignee: Mitsubishi Electric Corporation, Tokyo (JP)

(21) Appl. No.: 17/790,289

(22) PCT Filed: Mar. 6, 2020
(86) PCT No.: PCT/JP2020/009688

§ 371 Date: Jun. 30, 2022

(51) Int. Cl. G01S 7/02; G01S 7/03

(52) U.S. Cl. CPC G01S 7/027; G01S 7/03

(57) ABSTRACT

A millimeter wave radar device (1) disclosed in the present application is characterized by comprising a radio wave transmitter and receiver (2) formed with a transmitting and receiving surface (2fa) for transmitting millimeter waves to an outside and receiving reflected waves from an target, a controller (3) for controlling operation of the radio wave transmitter and receiver (2) and for calculating at least either a positional relationship or a relative velocity in relation to the target, and a waterproof housing (6) for accommodating the radio wave transmitter and receiver (2) and the controller (3) and for holding the radio wave transmitter and receiver such that a normal line (Ln) of the transmitting and receiving surface (2fa) is directed to a horizontal direction, wherein a front face (5ff) positioned in a front direction in a transmission direction of the millimeter waves among outer faces of the housing (6) is rearwardly inclined to a downward direction at a portion assigned as a radio wave passing area (Ar) corresponding to a region in a vertical direction and a left-right direction of the transmitting and receiving surface (2fa).

### CROSS REFERENCE TO RELATED APPLICATIONS

This application is a National Stage of International Application No. PCT/JP2020/009688 filed Mar. 6, 2020.

### TECHNICAL FIELD

The present application relates to a millimeter wave radar device.

### BACKGROUND ART

There is a millimeter wave radar device that uses a radio wave having a wavelength in a millimeter range of 30 to 300 GHz band, which is excellent in straightness and less affected by environmental changes due to fog and rain as compared with a laser. Such a millimeter wave radar device is installed outdoors at, for example, a road intersection, a railway crossing, a vehicle, or the like, and is used for measuring a distance and a relative velocity in relation to a target, or for detecting an obstacle in an environment exposed to rain.

However, the millimeter wave is attenuated when passing through a water film, and there is a possibility of lowering the detection accuracy of the radar. Therefore, a technique is disclosed in which a plurality of grooves are formed in a radio wave passing area in front of the radar and water droplets are sucked into the grooves by the capillary phenomenon to suppress formation of the water film in the radio wave passing area (refer to, for example, Patent Document 1).

### CITATION LIST

### Patent Document

Patent Document 1: Japanese Unexamined Patent Application Publication No. 2008-107283 (paragraphs 0011 to 0015, FIG. 1 to FIG. 3)

### SUMMARY OF INVENTION

### Problems to be Solved by Invention

However, in the structure in which water droplets are sucked into the grooves, even if the formation of a water film on the entire surface can be suppressed, striated water films along the grooves are formed in the radio wave passing area, and the detection accuracy of the radar may be lowered.

The present application discloses a technique for solving the above-mentioned problem, and an object of the present application is to obtain a millimeter wave radar device which maintains high detection accuracy even when exposed to rain.

### Means for Solving Problems

A millimeter wave radar device disclosed in the present application includes a radio wave transmitter and receiver formed with a transmitting and receiving surface for transmitting millimeter waves to an outside and receiving reflected waves from a target in the outside, a controller to control operation of the radio wave transmitter and receiver, and a waterproof housing to accommodate the radio wave transmitter and receiver and the controller and to hold the radio wave transmitter and receiver such that a normal line of the transmitting and receiving surface is directed to a horizontal direction, and is characterized in that the outer faces of the housing is provided with any of the following: rearward inclination of a portion assigned to a radio wave passing area, inclination of a top face in a left-right outward direction or frontward direction, installation of a visor, installation of a front groove, and installation of a bank.

### Effect of Invention

According to the millimeter wave radar device disclosed in the present application, it is possible to maintain a high detection accuracy even when the device is exposed to rain, because the retention of water droplets in the radio wave passing area is suppressed.

### BRIEF DESCRIPTION OF DRAWINGS

FIG. 1 is a cross-sectional view of a millimeter wave radar device according to Embodiment 1.

FIG. 2A and FIG. 2B are a side view and a front view of the millimeter wave radar device according to Embodiment 1, respectively.

FIG. 3A to FIG. 3C are front views of millimeter wave radar devices according to Embodiment 2 in each of which a top face is changed in shape.

FIG. 4 is a side view of a millimeter wave radar device according to Embodiment 3.

FIG. 5A and FIG. 5B are a side view and a front view of a millimeter wave radar device according to Embodiment 4, respectively.

FIG. 6A to FIG. 6C are a side view and a front view of a millimeter wave radar device, and a front view in which the top face is changed in shape, according to a variation example of Embodiment 4.

FIG. 7 is a side view of a millimeter wave radar device according to a second variation example of Embodiment 4.

FIG. 8A and FIG. 8B are a side view and a front view of a millimeter wave radar device according to Embodiment 5, respectively.

FIG. 9A and FIG. 9B are front views of the millimeter wave radar devices according to Embodiment 5 in each of which an arrangement of a visor is changed.

FIG. 10A and FIG. 10B are a side view and a front view of a millimeter wave radar device according to Embodiment 6, respectively.

FIG. 11A to FIG. 11C are front views of millimeter wave radar devices according to Embodiment 6 in each which the arrangement of the visor is changed.

FIG. 12A and FIG. 12B are a side view and a front view of a millimeter wave radar device according to a variation example of Embodiment 6, respectively.

FIG. 13A to FIG. 13C are front views of millimeter wave radar devices according to the variation example of Embodiment 6 in each of which the arrangement of the visor is changed.

FIG. 14A and FIG. 14B are a side view and a front view of a millimeter wave radar device according to Embodiment 7, respectively.

FIG. 15A to FIG. 15C are front views of millimeter wave radar devices according to Embodiment 7 in each of which the arrangement shape of the visor is changed.

FIG. 16A and FIG. 16B are a side view and a front view of a millimeter wave radar device according to Embodiment 8, respectively.

FIG. 17A and FIG. 17B are front views of millimeter wave radar devices according to Embodiment 8 in each of which the arrangement shape of a groove is changed.

FIG. 18A to FIG. 18C are a side view and a front view of a millimeter wave radar device according to a variation example of Embodiment 8, and a front view in which the arrangement shape of the groove is changed, respectively.

FIG. 19A and FIG. 19B are a side view and a front view of a millimeter wave radar device according to a second variation example of Embodiment 8, respectively.

FIG. 20A to FIG. 20C are front views of millimeter wave radar devices according to the second variation example of Embodiment 8 in each of which the arrangement shape of a double-groove portion is changed.

FIG. 21A and FIG. 21B are respective side views of a millimeter wave radar device according to Embodiment 9.

FIG. 22A and FIG. 22B are a side view and a front view of a millimeter wave radar device according to a variation example of Embodiment 9, respectively

FIG. 23A and FIG. 23B are a side view of a millimeter wave radar device according to Embodiment 2 and a side view of a millimeter wave radar device according to Embodiment 3, respectively, in each of which a front face is formed vertically.

FIG. 24A to FIG. 24C are side views for a millimeter wave radar device according to Embodiment 4, a variation example thereof, and a second variation example thereof, respectively, in each of which the front face is formed vertically.

FIG. 25 is a side view in a case where the front face of the millimeter wave radar device according to Embodiment 5 is formed vertically.

FIG. 26A and FIG. 26B are side views for a millimeter wave radar device according to Embodiment 6 and a variation example thereof, respectively, in each of which the front face is formed vertically.

FIG. 27 is a side view in a case where the front face of the millimeter wave radar device according to Embodiment 7 is formed vertically.

FIG. 28A to FIG. 28C are side views for a millimeter wave radar device according to Embodiment 8, a variation example thereof, and a second variation example thereof, respectively, in each of which the front face is formed vertically.

FIG. 29A and FIG. 29B are side views for a millimeter wave radar device according to Embodiment 9 and a variation example thereof, respectively, in each of which the front face is formed vertically.

### MODES FOR CARRYING OUT INVENTION

### Embodiment 1

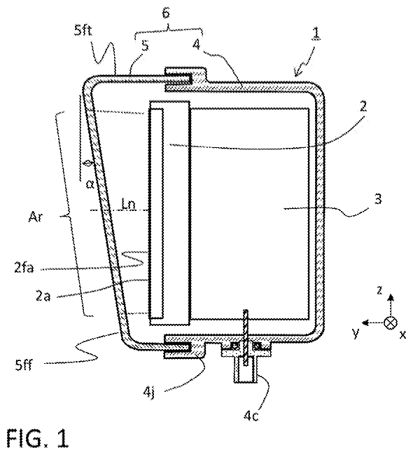

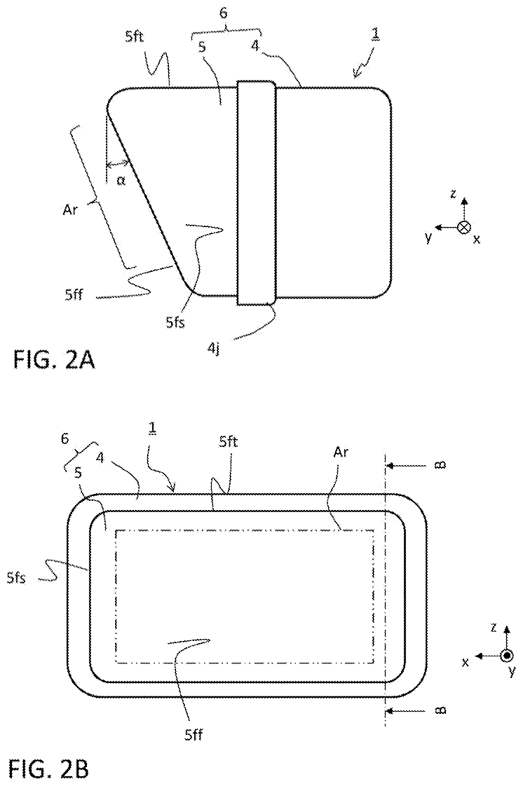

FIG. 1 and FIG. 2A, FIG. 2B are views for explaining a configuration of a millimeter wave radar device according to Embodiment 1, FIG. 1 is a cross-sectional view taken along a line B-B in FIG. 2B, which will be described later, showing an internal configuration of the millimeter wave radar device, FIG. 2A is a side view of the millimeter wave radar device, and FIG. 2B is a front view.

Note that, in the millimeter wave radar device, millimeter waves are radiated toward the horizontal direction, and the vertical direction is set to be the z-direction, and then the radiation direction is the positive direction in the y-direction, the positive side is set to be the front side, and the negative side is set to be the rear side. Then, the x direction is set to be the left-right direction, and the positive direction is set to be left. That is, the front view described above has a shape when the device is viewed from a position away in the positive direction of the y-direction. At the same time, the side view has a shape when the device viewed from the right side, namely, when viewed from a position that is away from the device in the negative direction in the x-direction and is drawn so as the front side to be on the left side.

The millimeter wave radar device 1 according to each embodiment of the present application, as shown in FIG. 1, a radio wave transmitter and receiver 2 including an antenna 2a having a directivity for transmitting millimeter waves to the outside and receiving reflected waves from a target, and a controller 3 for controlling the radio wave transmitter and receiver 2 are accommodated in a housing 6. The housing 6 is composed of a case 4 that is disposed mainly on the rear side and holds internal devices such as the controller 3, and a cover 5 that is formed of a material such as polycarbonate, which allows the millimeter waves to pass through, and is disposed on the front side of the antenna 2a. Note that, although details of the calculation, etc. are not described in the present application, the controller 3, as a control unit of the radar device has a function for calculating either a positional relationship or a relative speed in relation to the target on the basis of an output from the radio wave transmitter and receiver 2, and outputs the calculated result to an external device.

A connecting portion 4j to the cover 5 is formed in the case 4 on the rear side of the antenna 2a, and by fitting the cover 5 into the connecting portion 4j, the case 6 exhibits a waterproof function and prevents the internal devices from being wet by rainfall. Further, a connector 4c for electrically connecting to the external device (not shown) is provided at a lower part of the case 4. Furthermore, although not shown, a supporting part is formed in the case 4 for installing the millimeter wave radar device 1 such that a normal line Ln of a transmitting and receiving surface 2fa, which is the directional center of the antenna 2a, can be directed in a desired horizontal direction (y-direction in the figure). Note that the connector 4c is omitted from the side view and the front view, which is also in the following embodiments.

A front face 5ff of the cover 5 faces the transmitting and receiving surface 2fa of the antenna 2a and covers all the region (radio wave passing area Ar) in which the millimeter waves travel back and forth, which corresponds to a region (region in the x-z plane) in the vertical direction (z-direction) and the horizontal (x-direction) direction of the transmitting and receiving surface 2fa. As shown in FIG. 2A and FIG. 2B, a top face 5ft is substantially a horizontally flat surface, whereas in the front face 5ff, at least a portion assigned to the radio wave passing area Ar is rearwardly inclined downward in the vertical direction (z-direction). As will be described later, an inclination angle α of the portion assigned to the radio wave passing area Ar with respect to the vertical line is set to 3° to 45° as a range in which adhesion of water droplets to the radio wave passing area Ar can be effectively prevented during rainfall.

Next, operation will be described. The millimeter wave transmitted from the antenna 2a (the transmitting and receiving surface 2fa) passes through the radio wave passing area Ar of the cover 5, is bounced back from the target at a position away from the millimeter wave radar device 1, passes through the radio wave passing area Ar again, and is received by the antenna 2a. An electric signal corresponding to the received radio wave is outputted to the controller 3, and the controller 3 calculates a distance to the target and a relative velocity to the target from the electric signal, and outputs a calculated result to the outside via the connector 4c. Thus, for example, when the device is installed on a vehicle, it is possible to measure the distance and the relative speed in relation to the target such as another vehicle or a pedestrian, or to detect an obstacle.

Here, during rainfall, water droplets falling on the flat top face 5ft of the cover 5 evade the connecting portion 4j projecting upward and flow to a side face 5fs or on the side of the front face 5ff due to gravity. At this time, since the side face 5fs is not related to the transmission and reception of the radio waves, no matter how water droplets flow, there is no particular problem.

The front face 5ff except for the radio wave passing area Ar is not related to the transmission and reception of the radio waves, as is the case with the side face 5fs, and thus there is no particular problem, but in contrast, when water droplets retain in the radio wave passing area Ar, a water film is formed, and the detection accuracy is affected. However, in the millimeter wave radar device 1 according to Embodiment 1, since the portion assigned to the radio wave passing area Ar of the front face 5ff is inclined, water droplets are discharged by flowing downward without being retained, so that the adhesion is suppressed. That is, the attenuation of the radio waves by the water film is suppressed, thereby enabling high-precision detection.

Note that when the vehicle is exposed to a wind from the front side, or when the device is disposed on the front side of the vehicle traveling, there may be a case where the front face 5ff is directly exposed to water droplets. In this case, the front face 5ff is exposed to water droplets containing a component moving rearward, but water droplets do not retain in the radio wave passing area Ar because of the inclination and flow downward to be discharged, so that the adhesion of water droplets is suppressed, thereby enabling high-precision detection.

Here, when the inclination angle α is less than 3°, the effect of suppressing the retention of water droplets is reduced, and high-precision detection may be difficult. At the same time, even when the angle exceeds 45°, it is possible to maintain the effect of discharging water droplets, but the dimension in the front-rear direction becomes large, making it difficult to reduce the size of the device. Therefore, it is desirable that the inclination angle α should be set to 3° to 45°. Note that the optimum range of the inclination angle α is also common in the following embodiments.

### Embodiment 2

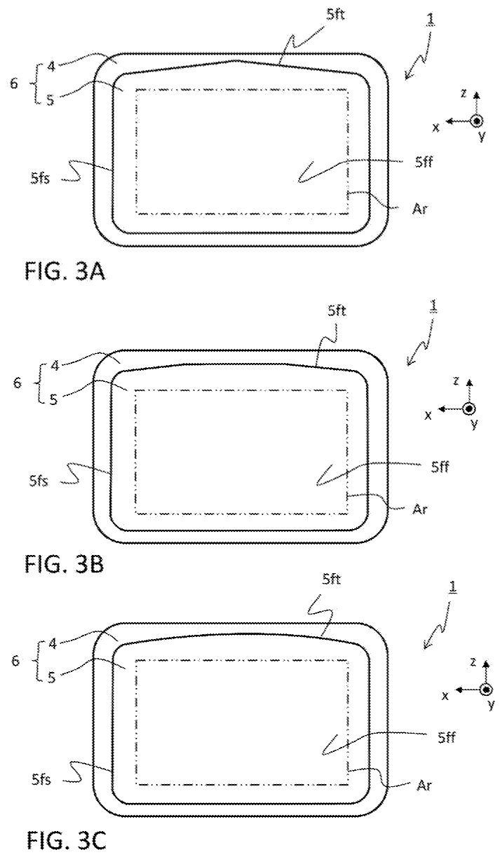

In Embodiment 1, an example in which the top face of the cover is formed flat has been described. In a millimeter wave radar device according to Embodiment 2, an example in which the top face of the cover is inclined with respect to the left-right direction will be described. FIG. 3A to FIG. 3C are front views showing examples of millimeter wave radar devices according to Embodiment 2 in each of which the shape of the inclination of the top face with respect to the left-right direction is changed. Note that the structure other than the top face is the same as that disclosed in Embodiment 1, and the description on the inclination of the portion assigned to the radio wave passing area is omitted. Further, about the state of the internal devices that are housed, FIG. 1 used in Embodiment 1 is referred to, and description of the same portions is omitted.

In the millimeter wave radar device 1 according to Embodiment 2, as shown in FIG. 3A, the top face 5ft of the cover 5 is downwardly inclined to an outward direction with a vertex at the center in the left-right direction. As a result, water droplets falling on the top face 5ft of the cover 5 during rainfall flows toward the side face 5fs dominantly rather than the front face 5ff due to gravity, so that the ratio of water droplets toward the front face 5ff can be reduced. Therefore, it is possible to suppress the retention of water droplets in the radio wave passing area Ar as compared with the case disclosed in Embodiment 1.

In FIG. 3A, an example is disclosed in which the top face 5ft has the vertex set in the center portion in the left-right direction and is linearly inclined to the outward direction as the shape thereof, but this is not a limitation. For example, as shown in FIG. 3B, the center portion in the left-right direction may be made flat, and regions on both sides to the flat portion may be linearly inclined to the outward direction.

Alternatively, as shown in FIG. 3C, the center in the left-right direction may be set as the vertex, and the top face may be inclined to the outward direction in an arc shape. In either case, water droplets falling on the top face 5ft of the cover 5 during rainfall flow toward the side face 5fs dominantly rather than the front face 5ff due to gravity, so that the ratio of water droplets toward the front face 5ff can be reduced and the retention of water droplets in the radio wave passing area Ar can be suppressed. Note that, even when the front face 5ff is exposed to water droplets containing a component moving rearward, water droplets do not retain in the radio wave passing area Ar because of the inclination and flow downward to be discharged, so that the adhesion of water droplets is suppressed, thereby enabling high-precision detection.

### Embodiment 3

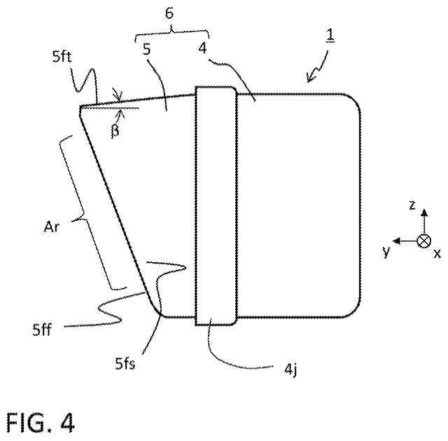

In Embodiment 1 or Embodiment 2, an example in which the top face is formed horizontally in the front-rear direction has been disclosed, but this is not a limitation. In a millimeter wave radar device according to Embodiment 3, an example in which the top face is inclined with respect to the front-rear direction will be described. FIG. 4 is a side view of the millimeter wave radar device according to Embodiment 3. Note that the structure other than the top face is the same as that disclosed in Embodiment 1, and the description on the inclination of the portion assigned to the radio wave passing area is omitted. Further, about the state of the internal devices that are housed, FIG. 1 used in Embodiment 1 is referred to, and description of the same portions is omitted.

In the millimeter wave radar device 1 according to Embodiment 3, as shown in FIG. 4, the top face 5ft of the cover 5 is made downwardly inclined to a front direction (inclination angle θ. As a result, water droplets falling on the top face 5ft of the cover 5 during rainfall flow toward the front face 5ff dominantly rather than the side face 5fs due to gravity. However, since the speed of water droplets toward the front face 5ff is larger than that in the case of the flat top face, the falling speed at the front face 5ff increases and they gain momentum, so that the retention time of water droplets in the radio wave passing area Ar can be shortened and the retention can be suppressed compared with the case disclosed in Embodiment 1. Therefore, when the front face 5ff is exposed to water droplets containing a component moving rearward, the momentum of the water can increase the effect of suppressing the retention of the water droplet in the radio wave passing area Ar.

### Embodiment 4

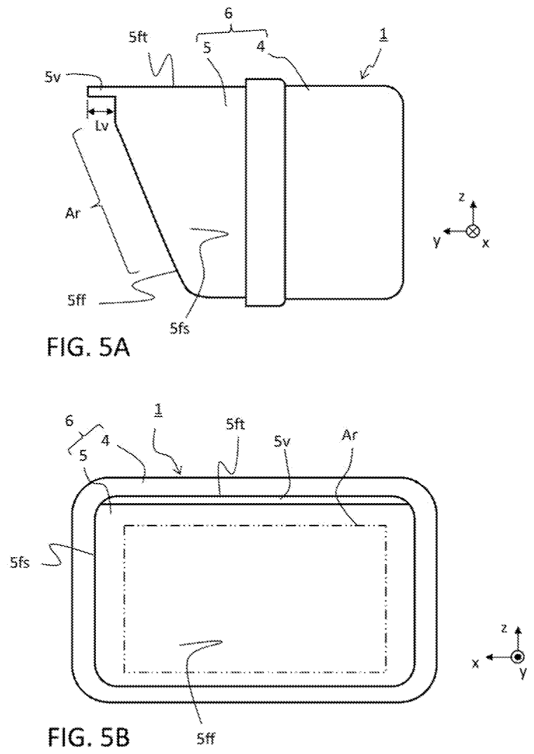

In Embodiment 1 to Embodiment 3, which are described above, examples in which the top face is continuous at the tip portion thereof with the front face has been described. In a millimeter wave radar device according to Embodiment 4, an example in which a visor projecting toward the front side is provided on the top face will be described. FIG. 5A and FIG. 5B are a side view and a front view of the millimeter wave radar device according to Embodiment 4, respectively. Note that the structure other than the top face is the same as that disclosed in Embodiment 1, and the description on the inclination of the portion assigned to the radio wave passing area is omitted. Further, about the state of the internal devices that are housed, FIG. 1 used in Embodiment 1 is referred to, and the description on the same portions is omitted.

As shown in FIG. 5A and FIG. 5B, the millimeter wave radar device 1 according to Embodiment 4 is provided with the visor 5v projecting toward the front further from the front face 5ff in the top face 5ft of the cover 5. The visor 5v are formed so as to extend over a region covering all the radio wave passing area Ar in the left-right direction, and an overhang amount Lv from the front face 5ff is set two times or more of a water droplet diameter, that is, 2 mm or more when the water droplet diameter is about 1 mm.

As a result, among water droplets falling on the top face 5ft of the cover 5 during rainfall, some of the water droplets flowing toward the front face 5ff side fall into the air at the tip portion of the visor 5v without being transferred to the side of the front face 5ff located rearward, thereby preventing the formation of the water film and enabling high-precision detection. Further, even when water droplets travel toward the front face 5ff after falling from the visor 5v into the air, most of water droplets can be dropped downward without touching the front face 5ff due to the inclination of the radio wave passing area Ar. Furthermore, even when reaching the front face 5ff, water droplets are discharged by flowing downward without being retained due to the inclination of the radio wave passing area Ar, so that the adhesion of water droplets is suppressed, and highly accurate detection can be performed.

### Variation Example

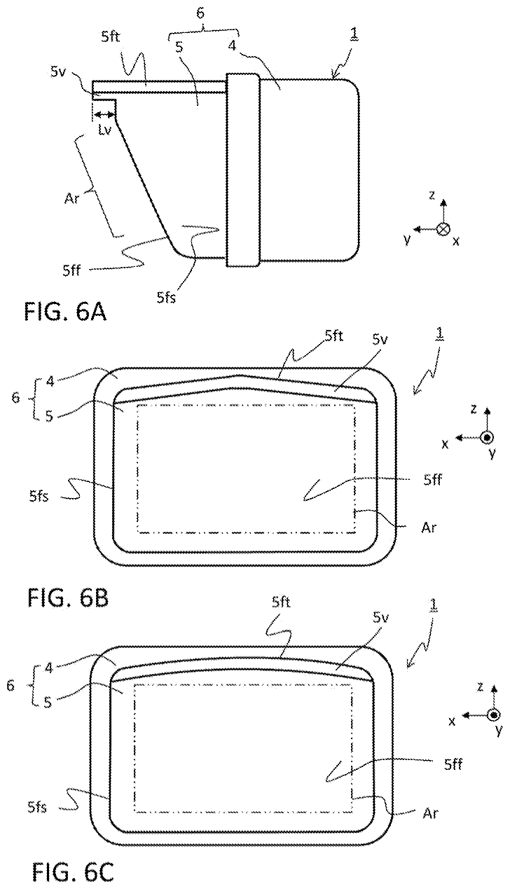

In the above example, an example in which the top face having the visor formed flat has been described. In a millimeter wave radar device according to the present variation example, an example in which the visor is formed to be inclined with respect to the left-right direction will be described. FIG. 6A and FIG. 6B show a side view and a front view of the millimeter wave radar device according to the variation example, respectively. FIG. 6C is a front view showing an example in which the shape of the visor inclined with respect to the left-right direction is changed.

As shown in FIG. 6A and FIG. 6B, the millimeter wave radar device 1 according to the present variation example is configured such that the top face 5ft having the visor 5v is inclined downward and outward, with the vertex at the center in the left-right direction. As a result, water droplets falling on the top face 5ft of the cover 5 during rainfall flow toward the side face 5fs dominantly rather than the front face 5ff due to gravity, so that the ratio of water droplets toward the front face 5ff can be reduced. Furthermore, water droplets directed toward the tip side of the visor 5v can also be dropped into the air without being transferred to the front face 5ff. Therefore, it is possible to suppress the retention of water droplets in the radio wave passing area Ar as compared with the case disclosed in Embodiment 4.

In FIG. 6B, an example is disclosed in which the visor 5v is downwardly inclined linearly to the outward direction along the shape of the top face 5ft, with the vertex at the center in the left-right direction. For example, as shown in FIG. 6C, the center in the left-right direction may be set as the vertex and the visor may be downwardly inclined to the outward direction in an arc shape. In either case, water droplets falling on the top face 5ft during rainfall flow toward the side face 5fs dominantly rather than toward the front face 5ff due to gravity, so that the ratio of water droplets toward the front face 5ff can be reduced and the retention of water droplets in the radio wave passing area Ar can be suppressed.

### Second Variation Example

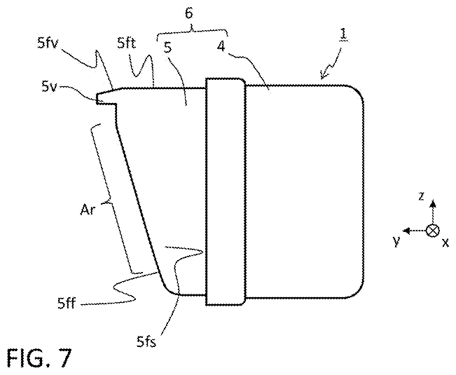

In the example described above, the top face in the front-rear direction formed horizontally has been disclosed as an example, but this is not a limitation. In a millimeter wave radar device according to the second variation example, an example in which the visor is made inclined in the front-rear direction will be described. FIG. 7 is a side view of the millimeter wave radar device according to the second variation example.

As shown in FIG. 7, in the millimeter wave radar device 1 according to the second variation example, an inclined portion 5fv downwardly inclined to the front direction is provided at a portion of the visor 5v projecting from the front face 5ff in the top face 5ft of the cover 5. As a result, among water droplets falling on the top face 5ft of the cover 5 during rainfall, some of the water droplets that travel to the inclined portion 5fv flow faster than in the case where the visor is flat, so that separation thereof at the tip portion is improved and water droplets fall into the air without reaching the front face 5ff. This makes it possible to suppress the retention of water droplets in the radio wave passing area Ar.

### Embodiment 5

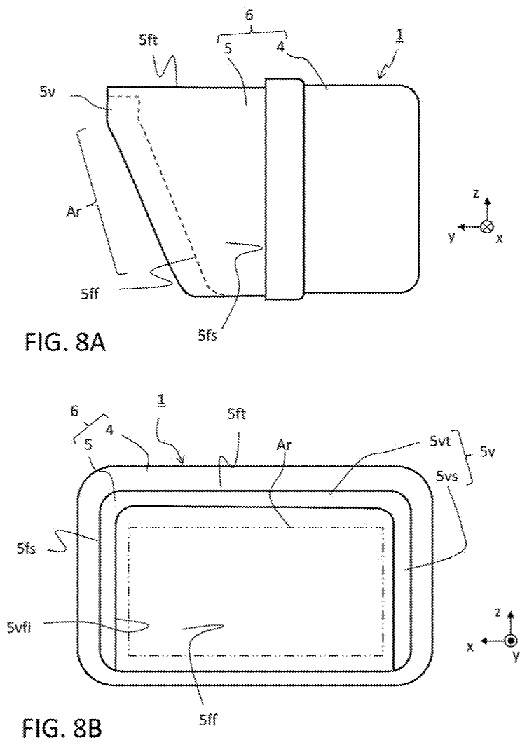

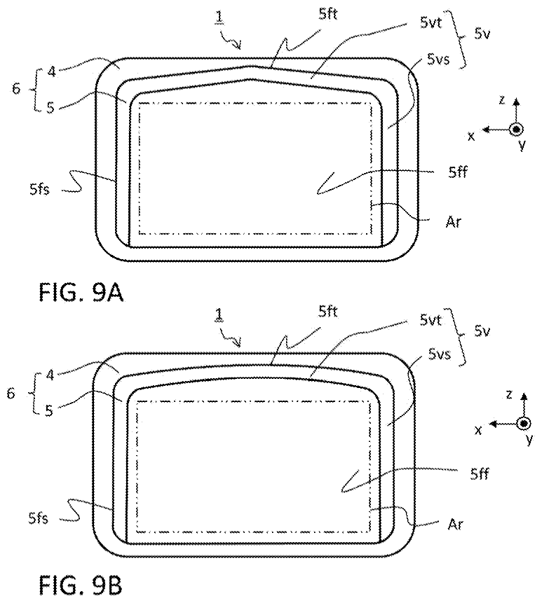

In Embodiment 4, an example in which the visor is provided only on the top face has been described. In a millimeter wave radar device according to Embodiment 5, an example in which the visor projecting toward the front is extended from the top face over both of the side faces will be described. FIG. 8A, FIG. 8B and FIG. 9A, FIG. 9B are views for explaining the millimeter wave radar device according to Embodiment 5, FIG. 8A is a side view and FIG. 8B is a front view of the millimeter wave radar device, and FIG. 9A and FIG. 9B are front views showing examples in each of which the shape of the top face is changed as an arrangement shape of the visor. Note that the structure other than that relates to the visor provided is the same as that disclosed in Embodiment 4, and the description on the same portions will be omitted.

In the millimeter wave radar device 1 according to Embodiment 5, as shown in FIG. 8A and FIG. 8B, the visor 5v projecting toward the front further from the front face 5ff is provided so as to extend from the top face 5ft over both of the side faces 5fs. The visor 5v is basically formed in a region extending from one side face 5fs (left side in FIG. 8B) to the other side face 5fs (right side in FIG. 8B) via the top face 5ft and include a radio wave passing area Ar within an inner peripheral face 5vfi.

As a result, among water droplets falling on the top face 5ft of the cover 5 during rainfall, even if some of the water droplets flow to the front face 5ff side and reach a tip portion of a top face portion 5vt projecting from the top face 5ft, these water droplets fall into the air before reaching the front face 5ff, thereby preventing the formation of the water film and enabling high-precision detection. Furthermore, water droplets approaching the front face 5ff from the left-right direction can be prevented from adhering to the front face 5ff by a side face portion 5vs projecting from the side faces 5fs. In addition, even if water droplets passing through the side face 5fs flow to the front direction, water droplets do not come around the front face 5ff side but fall downward along the tip portion of the side face portion 5vs or are released into the air.

Note that, although FIG. 8A, FIG. 8B show an example in which the visor 5v is provided when the top face 5ft is formed flat, this is not a limitation. For example, as shown in FIG. 9A, the top face 5ft may be downwardly inclined linearly to the outward direction (refer to FIG. 3A of Embodiment 2), with the vertex at the center in the left-right direction. Alternatively, as shown in FIG. 9B, it may be downwardly inclined to the outward direction in an arc shape (refer to FIG. 3C of Embodiment 2), with the vertex at the center in the left-right direction.

In either case, water droplets falling on the top face 5ft of the cover 5 during rainfall flow toward the side face 5fs dominantly rather than the front face 5ff due to gravity, so that the ratio of water droplets toward the front face 5ff can be reduced and the retention of water droplets in the radio wave passing area Ar can be suppressed. Further, by providing the side face portion 5vs that is continuous with the top face portion 5vt, it is possible to prevent water droplets traveling in the left-right direction and traveling in the front-rear direction on the side face 5fs from entering the radio wave passing area Ar.

### Embodiment 6

In Embodiment 4 or Embodiment 5, which are described above, an example in which the visor is simply projected to the front side has been described. In a millimeter wave radar device according to Embodiment 6, an example in which a recessed step is provided in an inner side of the visor will be described.

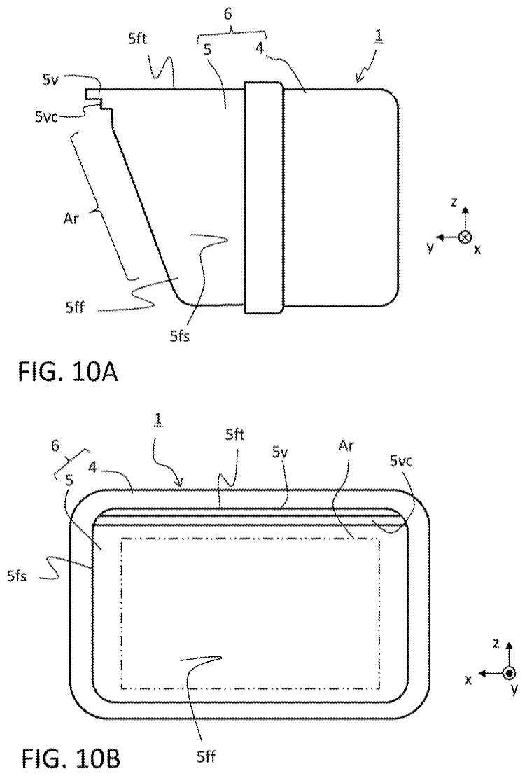

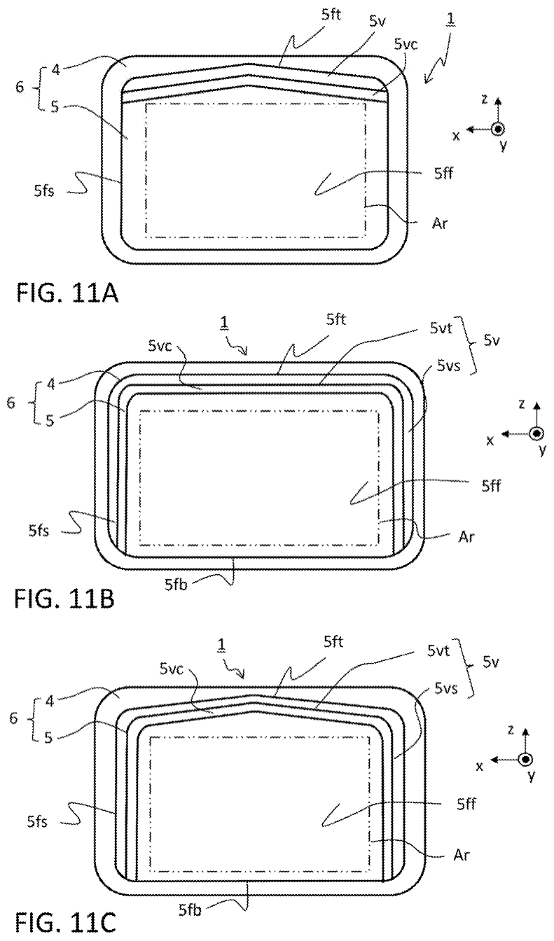

FIG. 10A. FIG. 10B and FIG. 11A to FIG. 11C are used in the description of the millimeter wave radar device according to Embodiment 6, and FIG. 10A is a side view of the millimeter wave radar device and FIG. 10B is a front view thereof. FIG. 11A to FIG. 11C are front views showing an example in which the shape of the top face is changed and examples in which side face portions are formed according to two kinds of shapes of top faces, as each of arrangement shapes of the visor. Note that the structure other than that relates to the visor provided is the same as that disclosed in Embodiment 4 or Embodiment 5, and the description on the same portions will be omitted.

In the millimeter wave radar device 1 according to Embodiment 6, as shown in FIG. 10A and FIG. 10B, the visor projecting toward the front further from the front face 5ff has the recessed step 5vc provided on a face (so-called back side) of the visor 5v closer to the front face 5ff. The step 5vc is formed so as to have a level difference of not less than the water droplet diameter (1 mm) to have an action such that the path of water droplets reaching from the tip portion to the front face 5ff is cut off.

As a result, among water droplets falling on the top face 5ft of the cover 5 during rainfall, even if some of the water droplets flow to the front face 5ff side and reach the tip portion of the top face portion 5vt, water droplets fall into the air because of the cut-off by the step 5vc on the way to the front face 5ff side, thereby preventing the formation of the water film and enabling highly accurate detection.

Note that, although FIG. 10A, FIG. 10B show an example in which the visor 5v is provided when the top face 5ft is formed flat, this is not a limitation. For example, as shown in FIG. 11A, the top face 5ft may be downwardly inclined linearly to the outward direction (similar to FIG. 3A of Embodiment 2), with the vertex at the center in the left-right direction. In this case, as described in Embodiment 2, not only the effect of making water droplets flow dominantly toward the side face 5fs is obtained but also water droplets that reach the recessed step 5vc and are not cut off can be moved outward along the inclination in the left-right direction and dropped off at open ends of the side faces 5fs that are outside the radio wave passing area Ar.

Alternatively, as shown in FIG. 11B, by providing the side face portion 5vs and extending the step 5vc so as to be open at a bottom face 5fb, it is possible to prevent water droplets from entering from the side. In this case, even if water droplets retained at the step 5vc of the top face portion 5vt, when water droplets are moved to the side of the side face portion 5vs due to some unknown factor, the step 5vc of the side face portion 5vs serves as a guide, and water droplets are guided to be discharged at the side of the bottom face 5fb, thereby preventing the influence on the radio wave passing area Ar. At this time, as shown in FIG. 11C, when the top face 5ft is inclined with respect to the left-right direction, it is possible to further guide water droplets to the outward direction.

### Variation Example

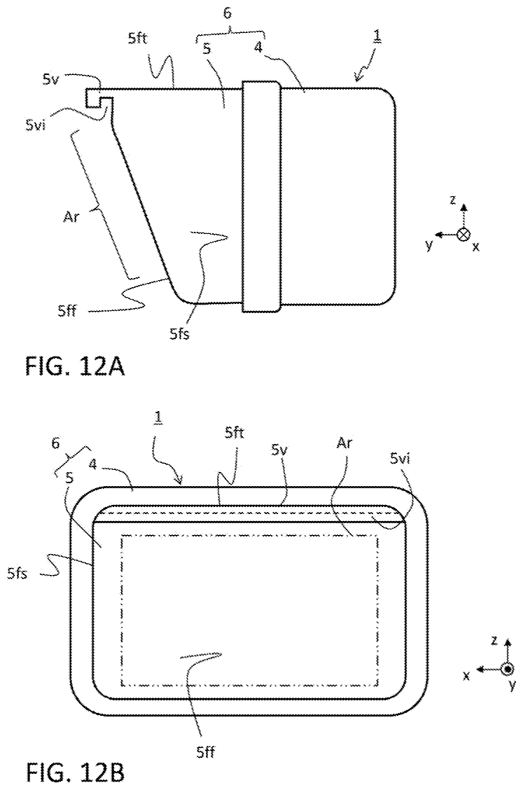

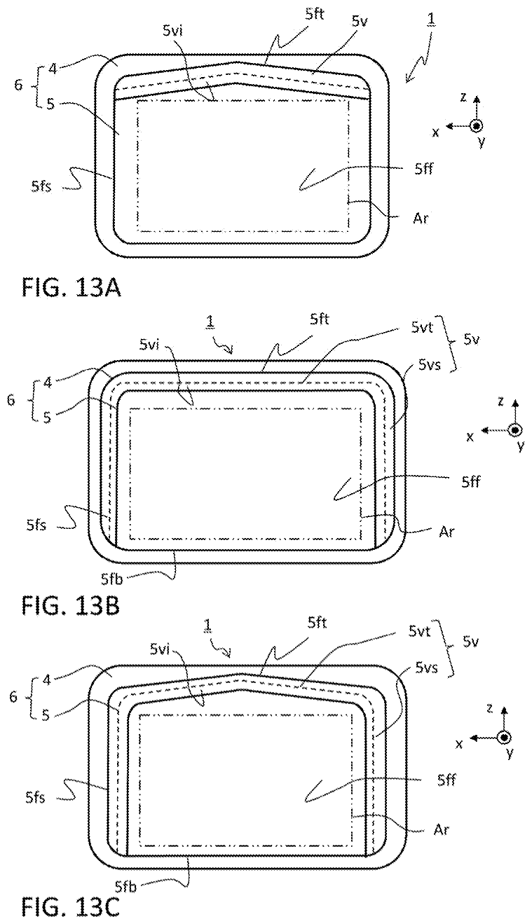

In the above example, an example in which the recessed step is formed on the face of the visor closer to the front face in order to cut off water droplets has been described. In a millimeter wave radar device according to the present variation example, an example in which a cut-off groove is formed on the face of the visor closer to the front face will be described. FIG. 12A and FIG. 12B show a side view and a front view of the millimeter wave radar device according to the variation example, respectively. FIG. 13A to FIG. 13C are front views showing an example in which the shape of the top face is changed and examples in which side face portions are also formed according to two kinds of shapes of top faces, as each of arrangement shapes of the visor.

As shown in FIG. 12A and FIG. 12B, in the millimeter wave radar device 1 according to the present variation example, the visor 5v projecting toward the front further from the front face 5ff has the cut-off groove 5vi on the face of the visor 5v closer to the front face 5ff. The cut-off groove 5vi is formed so as to have a groove width and depth equal to or greater than the diameter of a water droplet to have an action such that the path of the water droplet reaching from the tip portion to the front face 5ff is cut off.

As a result, among water droplets falling on the top face 5ft of the cover 5 during rainfall, even if some of the water droplets flow to the front face 5ff side and reach the tip portion of the top face portion 5vt, water droplets fall into the air because of the cut-off by the cut-off groove 5vi on the way to the front face 5ff side, thereby preventing the formation of the water film and enabling highly accurate detection.

In FIG. 12A, FIG. 12B, an example in which the visor 5v is provided when the top face 5ft is formed flat is disclosed, but this is not a limitation. For example, as shown in FIG. 13A, the top face 5ft may be downwardly inclined linearly to the outward direction (similar to FIG. 11A), with the vertex at the center in the left-right direction. In this case, as described in Embodiment 2, not only the effect of making water droplets flow dominantly toward the side face 5fs is obtained but also water droplets that is not cut off by the cut-off groove 5vi and remained can be moved along the inclination of the cut-off groove 5vi to the open ends of the side faces 5fs and dropped off at a portion outside the radio wave passing area Ar.

Alternatively, as shown in FIG. 13B, by providing the side face portion 5vs and extending the cut-off groove 5vi down to be open at a bottom face 5fb, it is possible to prevent water droplets from entering from the side. Further, even if water droplets are retained in the cut-off groove 5vi of the top face portion 5vt, and when water droplets reach the side of the side face portion 5vs due to some force, water droplets can be guided to be discharged from the side of the bottom face 5fb through the cut-off groove 5vi of the side face portion 5vs, thereby preventing the influence on the radio wave passing area Ar. At this time, as shown in FIG. 13C, when the top face 5ft is inclined with respect to the left-right direction, it is possible to further guide the water droplet to the outward direction.

### Embodiment 7

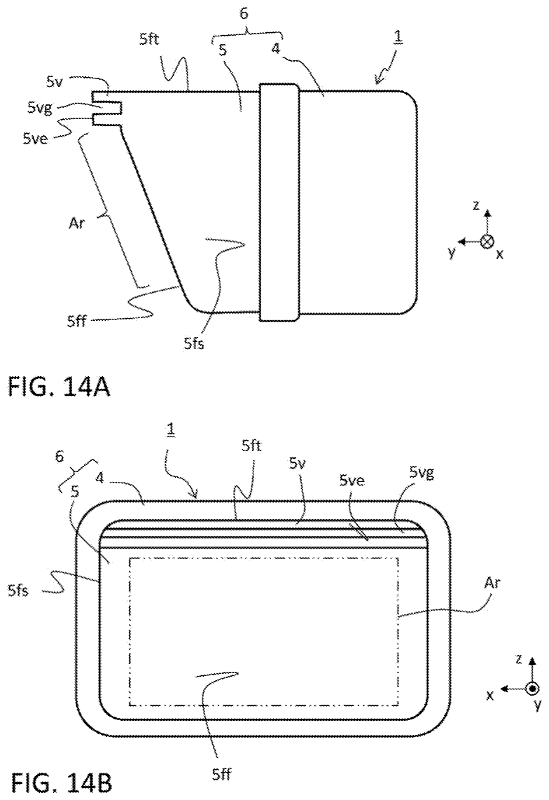

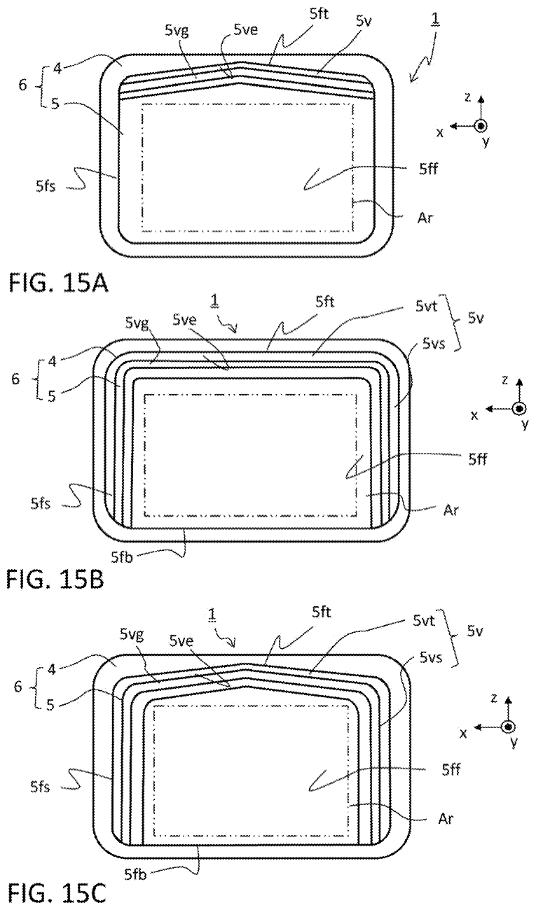

In Embodiment 6, an example in which the step or the groove is formed on the back side of the visor in order to cut off the water droplet has been described. In a millimeter wave radar device according to Embodiment 7, a description will be given on an example in which a groove for sucking water by the capillary phenomenon and guiding the water to a moving path is formed at a tip of the visor. FIG. 14A and FIG. 14B show a side view and a front view of the millimeter wave radar device according to Embodiment 7, respectively. FIG. 15A to FIG. 15C are front views showing an example in which the shape of the top face is changed and examples in which side face portions are also formed according to two kinds of shapes of top faces, as each of arrangement shapes of the visor.

In the millimeter wave radar device 1 according to Embodiment 7, as shown in FIG. 14A and FIG. 14B, a tip groove 5vg that exhibits a capillary action is provided on the tip 5ve of the visor 5v such that the groove extends over the radio wave passing area Ar and both ends thereof are open at the side faces 5fs. The tip groove 5vg is formed with a groove width of 1 mm or less so that water droplets moved to the tip 5ve can be sucked into the tip groove 5vg by the capillary phenomenon.

As a result, among water droplets falling on the top face 5ft of the cover 5 during rainfall, even if some of the water droplets flow to the front face 5ff side and reach the tip 5ve of the visor 5v, they are sucked up into the tip groove 5vg. The sucked water is guided along the extending direction (left-right direction) of the visor 5v to the outside of the radio wave passing area Ar and falls into the air at the open ends in the left-right direction, thereby preventing the formation of the water film and enabling highly accurate detection.

Although FIG. 14A, FIG. 14B show an example in which the visor 5v is provided when the top face 5ft is formed flat, this is not a limitation. For example, as shown in FIG. 15A, the top face 5ft may be downwardly inclined linearly to the outward direction (similar to FIG. 13A), with the vertex at the center in the left-right direction. In this case, as described in Embodiment 2, not only the effect of making water droplets flow dominantly toward the side face 5fs is obtained but also water droplets that is sucked by the tip groove 5vg can be moved outward along the inclination in the left-right direction and dropped off at an portion outside the radio wave passing area Ar.

Alternatively, even if water droplets aren't discharged at the side face 5fs, as shown in FIG. 15B, by providing the side face portion 5vs and extending the tip groove 5vg so as to be open at the bottom face 5fb, it is possible to prevent water droplets from entering from the side. Furthermore, even if water droplets are retained in the tip groove 5vg of the top face portion 5vt, and when water droplets reach the side of the side face portion 5vs due to some force, water droplets can be guided to be discharged from the side of the bottom face 5fb through the tip groove 5vg of the side face portion 5vs, thereby preventing the influence on the radio wave passing area Ar. At this time, as shown in FIG. 15C, when the top face 5ft (visor 5v) is inclined with respect to the left-right direction, it is possible to further guide the water droplet to the outward direction.

### Embodiment 8

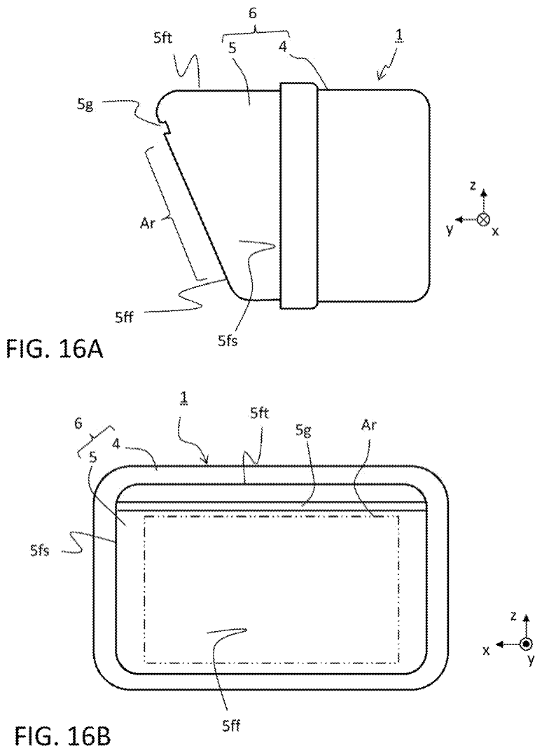

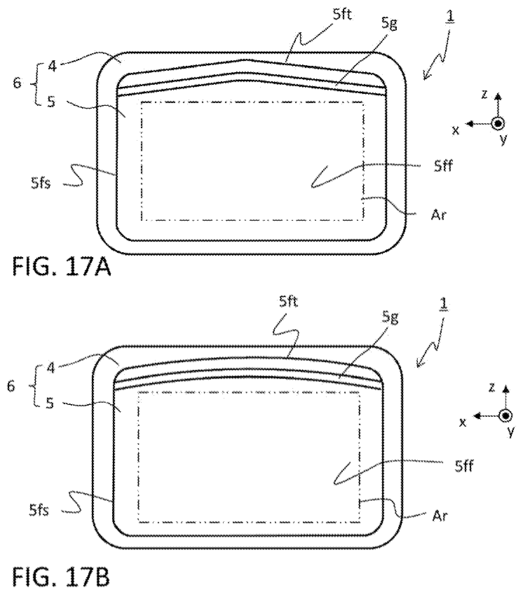

In Embodiment 4 to Embodiment 7, which are described above, examples in which the visor is provided so that water droplets received on the top face or the side faces do not come close to the radio wave passing area has been described. In a millimeter wave radar device according to Embodiment 8, a description will be given on an example in which a groove is provided for preventing water droplets reaching a front portion from approaching the radio wave passing area. FIG. 16A, FIG. 16B and FIG. 17A, FIG. 17B are views for explaining the millimeter wave radar device according to Embodiment 8, and FIG. 16A and FIG. 16B are a side view and a front view of the millimeter wave radar device, respectively. FIG. 17A and FIG. 17B each show a front view when the groove is applied to the front face in a case of the top face with a different shape. Note that the structure other than the groove is the same as that disclosed in Embodiment 1, and the description on the inclination of the portion assigned to the radio wave passing area is omitted. Further, about the state of the internal devices that are housed, FIG. 1 used in Embodiment 1 is referred to, and the description on the same portions is omitted.

As shown in FIG. 16A and FIG. 16B, the millimeter wave radar device 1 according to Embodiment 8 is provided with a front groove 5g that is opened in the front direction and extends in the left-right direction above the radio wave passing area Ar of the front face 5ff. The front groove 5g is formed so as to extend over all the radio wave passing area Ar in the left-right direction and to be open at the both ends at the side faces 5fs, and is set to a width of 1 mm or less so as to suck water droplets crossing the front groove 5g by the capillary phenomenon.

As a result, among water droplets falling on the top face 5ft of the cover 5 during rainfall, some of the water droplets flowing toward the front face 5ff side are sucked into the front groove 5g when crossing the front groove 5g. The sucked water is guided along the extending direction (left-right direction) of the front groove 5g to the outside of the radio wave passing area Ar and falls into the air at the open ends in the left-right direction, thereby preventing the formation of the water film and enabling highly accurate detection. In addition, compared with the case where the visor 5v is provided, since there is no projecting portion forward, it is possible to make the structure more compact.

Note that, in FIG. 16A, FIG. 16B, an example in which the front groove 5g is provided when the top face 5ft is formed flat is disclosed. For example, as shown in FIG. 17A, the top face 5ft may be downwardly inclined linearly to the outward direction (similar to FIG. 13A), with the vertex at the center in the left-right direction. Alternatively, as shown in FIG. 17B, it may be formed to match the top face 5ft formed in an arc-shape. In either case, as described in Embodiment 2, not only the effect of making water droplets flow dominantly toward the side face 5fs is obtained but also water droplets that is sucked by the front groove 5g can be moved along the inclination outward in the left-right direction and dropped off at an portion outside the radio wave passing area Ar.

Alternatively, although not shown, as the extending direction, the front groove 5g may be formed such that it is downwardly inclined to the outward direction regardless of the shape of the top face 5ft.

### Variation Example

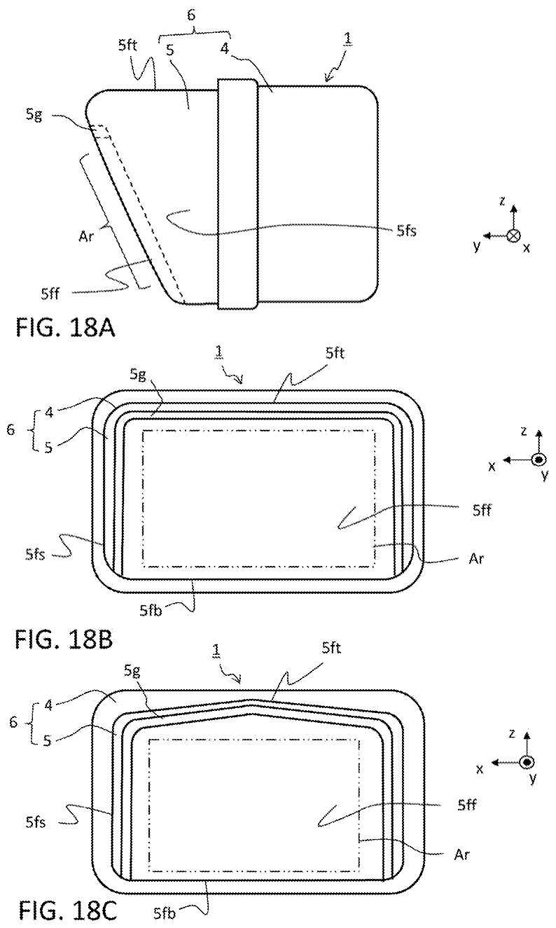

In the above example, an example in which both ends of the front groove are open at the side faces has been described. In a millimeter wave radar device according to the present variation example, an example in which the front groove at the both sides in the left-right direction are formed along the side face so as to be open at the bottom face will be described. FIG. 18A and FIG. 18B show a side view and a front view of a millimeter wave radar device according to the variation example, respectively. Further, FIG. 18C is a front view showing an example in which the shape of the top face is changed.

As shown in FIG. 18A and FIG. 18B, the millimeter wave radar device 1 according to the present variation example is provided with the front groove 5g that extends from vicinity of the top face 5ft along the top face 5ft and both side faces 5fs so as to be open at the bottom face 5fb. As a result, it is possible to prevent not only water droplets flowing from the top face 5ft side to the front face 5ff side but also water droplets flowing from the side faces 5fs to the front face 5ff from entering the radio wave passing area Ar. Further, water flowing from the top face 5ft side and sucked into the front groove 5g can be guided along the front groove 5g to the bottom face 5fb.

Note that FIG. 18A and FIG. 18B show examples in which the front groove 5g is formed along the shape of the flat top face 5ft, but this is not a limitation. For example, as shown in FIG. 18C, the front groove 5g may be formed along the top face 5ft downwardly inclined to the outward direction, with the vertex at the center in the left-right direction. In this case, water droplets falling on the top face 5ft during rainfall flow dominantly toward the side face 5fs rather than toward the front face 5ff due to gravity, so that the ratio of water droplets toward the front face 5ff can be reduced and the retention of water droplets in the radio wave passing area Ar can be suppressed. Further, along the inclination of the front groove 5g, water droplets flowing from the top face 5ft to the front face 5ff can be further guided out of the radio wave passing area Ar.

### Second Variation Example

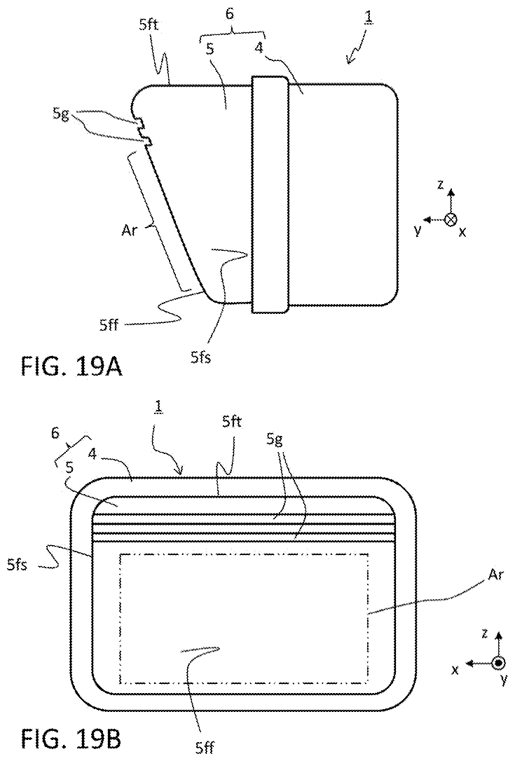

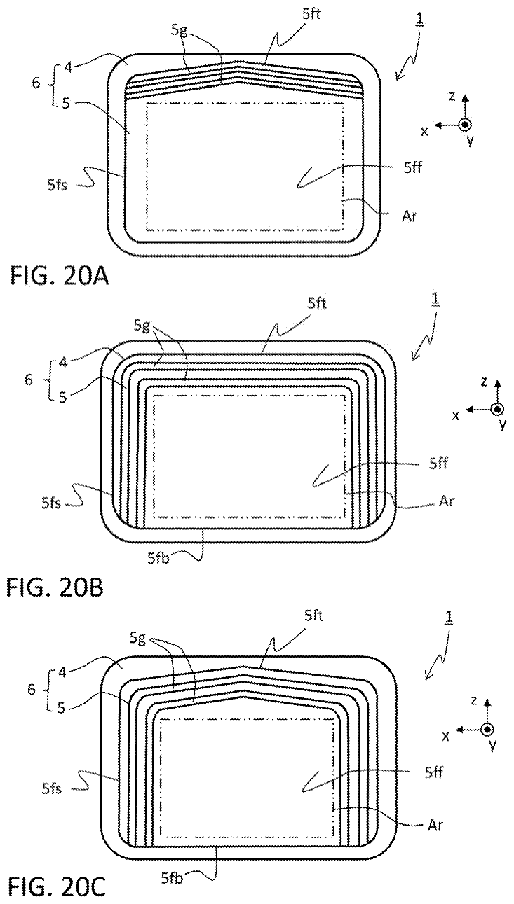

Although an example in which one front groove is provided has been disclosed in the above example, this is not a limitation. In a millimeter wave radar device according to the second variation example, an example in which two front grooves are provided as an example of a plurality of front grooves will be described. FIG. 19A, FIG. 19B and FIG. 20A to FIG. 20C are views for explaining the millimeter wave radar device according to the second variation example, and FIG. 19A and FIG. 19B are a side view and a plan view of the millimeter wave radar device according to the second variation example, respectively. Further, FIG. 20A to FIG. 20C are front views showing an example in which the shape of the top face is changed and examples in which the front grooves are formed to extend to the bottom face according to two kinds of shapes of top faces, as each of arrangement shapes of the front groove.

As shown in FIG. 19A and FIG. 19B, in the millimeter wave radar device 1 according to the second variation example, the two front grooves 5g are formed along the top face 5ft at positions on upper side of the radio wave passing area Ar of the front face 5ff so as to be open at the side faces 5fs. The two front grooves are formed with a groove width of 1 mm or less in common so as to exhibit a capillary action.

As a result, among water droplets falling on the top face 5ft of the cover 5 during rainfall, some of the water droplets flowing toward the front face 5ff side are sucked into the front grooves 5g when crossing the front grooves 5g. At this time, even if water droplets are not sucked into the first (outer) front groove 5g, they will be sucked into the second (inner) front groove 5g, whereby water droplets can be reliably sucked into the front grooves 5g. The sucked water is guided along the extending direction (left-right direction) of the front grooves 5g to the outside of the radio wave passing area Ar and falls into the air at the open ends in the left-right direction, thereby preventing the formation of the water film and enabling highly accurate detection. Even if the plurality of front grooves 5g are provided at intervals, there is no projecting portion forward compared with the case where the visor 5v is provided, so that the structure can be made compact.

In FIG. 19A, FIG. 19B, an example in which the front grooves 5g are provided when the top face 5ft is formed flat is disclosed, but this is not a limitation. For example, as shown in FIG. 20A, the top face 5ft may be downwardly inclined linearly to the outward direction (similar to FIG. 17A), with the vertex at the center in the left-right direction. As a result, water sucked into the front grooves 5g can be guided to the side of the open ends due to gravity.

Alternatively, as shown in FIG. 20B and FIG. 20C, the front grooves 5g may be formed to extend from vicinity of the top face 5ft along the top face 5ft and both side faces 5fs so as to be open at the bottom face 5fb. As a result, it is possible to prevent not only water droplets flowing from the top face 5ft side to the front face 5ff side but also water droplets flowing from the side faces 5fs to the front face 5ff from entering the radio wave passing area Ar. Further, water flowing from the top face 5ft side and sucked into the front grooves 5g can be guided along the front grooves 5g up to the bottom face 5fb.

Note that a portion of the front grooves 5g extending in the vertical direction on the sides to the radio wave passing area Ar does not necessarily need to be disposed in the front face 5ff, the grooves may be opened in the left-right direction, for example, and they may come around the side faces 5fs to be open at the lower end of the side faces 5fs.

### Embodiment 9

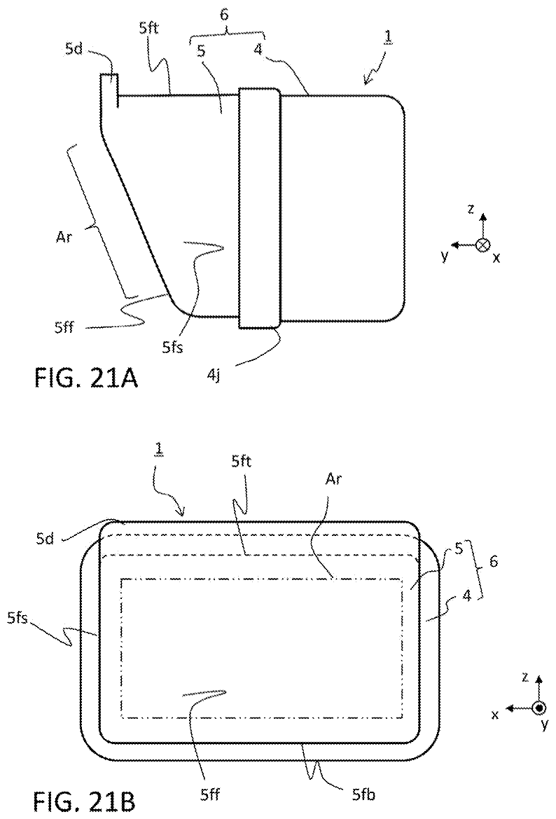

In Embodiment 4 to Embodiment 7, which are described above, examples in which the visor is provided in order to suppress the entry of water droplets into the radio wave passing area has been described. In a millimeter wave radar device according to Embodiment 9, an example in which a bank for preventing the flow of water droplets to the front face is provided at a boundary portion between the front face and the top face will be described. FIG. 21A and FIG. 21B are a side view and a front view of the millimeter wave radar device according to Embodiment 9, respectively. The structure other than the bank are the same as that disclosed in Embodiment 1, and the description on the inclination of the portion assigned to the radio wave passing area portion is omitted. Further, about the state of the internal devices that are housed, FIG. 1 used in Embodiment 1 is referred to, and the description on the same portions is omitted.

As shown in FIG. 21A and FIG. 21B, the millimeter wave radar device 1 according to Embodiment 9 is provided with the bank 5d projecting upward at a front end portion that is a boundary portion between the top face 5ft and the front face 5ff. The bank 5d is formed so as to extend over a region covering all the radio wave passing area Ar in the left-right direction, and the height of the bank 5d projecting from the top face 5ft is set to be twice or more, that is, 2 mm or more when the diameter of a water droplet is 1 mm.

As a result, water droplets falling on the top face 5ft of the cover 5 during rainfall are prevented from flowing to the front face 5ff side by the bank 5d and flow down only toward the side faces 5fs. Therefore, water droplets other than the water droplets directly approaching from the air or coming around from the side faces 5fs are not transferred toward the front face 5ff, and the formation of the water film in the radio wave passing area Ar is prevented to enable high-precision detection.

### Variation Example

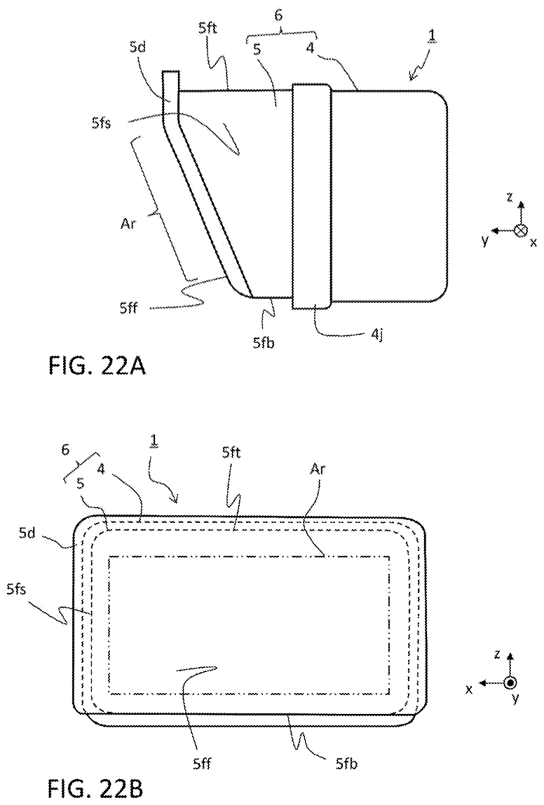

In the above example, an example in which the bank is provided only on the top face has been described, but this is not a limitation. In a millimeter wave radar device according to the variation example, an example in which the bank is extended until it reaches the bottom face will be described. FIG. 22A and FIG. 22B are a side view and a front view of a millimeter wave radar device according to the variation example, respectively.

As shown in FIG. 22A and FIG. 22B, the millimeter wave radar device 1 according to the present variation example has the bank 5d provided at the front end portion of the top face 5ft until it reaches the bottom face 5fb via front end sides of both side faces 5fs.

As a result, water droplets falling on the top face 5ft of the cover 5 during rainfall are prevented from flowing to the front face 5ff side by the bank 5d and flow down only toward the side faces 5fs. Further, also in the side faces 5fs, since water droplets are prevented from coming around toward the front face 5ff, water droplets are not transferred toward the front face 5ff except for the water droplets that directly approach from the air, and the formation of the water film in the radio wave passing area Ar is prevented, thereby enabling high-precision detection.

Note that, although various exemplary embodiments and examples are described in the present application, various features, aspects, and functions described in one or more embodiments are not inherent in the application of the contents disclosed in a particular embodiment and can be applicable alone or in their various combinations to each embodiment. Accordingly, countless variations that are not illustrated are envisaged within the scope of the art disclosed herein. For example, the case where at least one component is modified, added or omitted, and the case where at least one component is extracted and combined with a component in another embodiment disclosed are included.

For example, although the housing 6 is formed by combining the cover 5 and the case 4 that are separated by the vertical direction, this is not a limitation. For example, members separated by the horizontal direction may be combined, such as a combination of the bottom portion and the others, or members separated by an oblique direction may be combined. However, since the thickness of the connecting portion is larger than that of the other portions, and the transmittance of the radio wave changes, it is desirable that the radio wave passing area Ar should be all covered by one member in any case.

In particular, in the millimeter wave radar device 1 according to Embodiment 2 to Embodiment 9, examples of combinations are shown in which the inclination provided in the portion assigned to the radio wave passing area Ar described in Embodiment 1 is combined with each of the characteristic configurations. As a result, it is possible to remarkably suppress the retention of water droplets in the radio wave passing area Ar by the synergistic effect of the characteristic parts of Embodiment 2 to Embodiment 9 and the inclination in the portion assigned to the radio wave passing area Ar, but this is not a limitation.

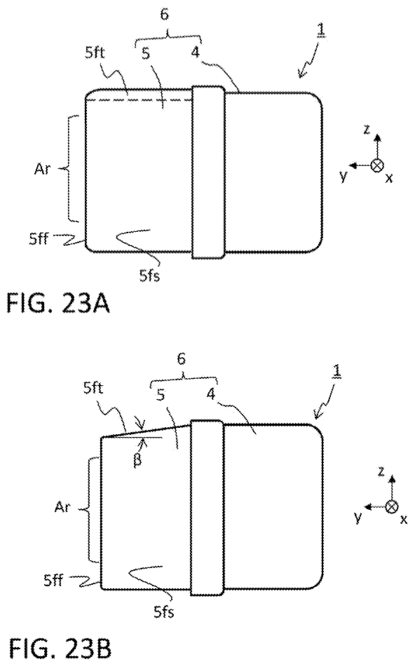

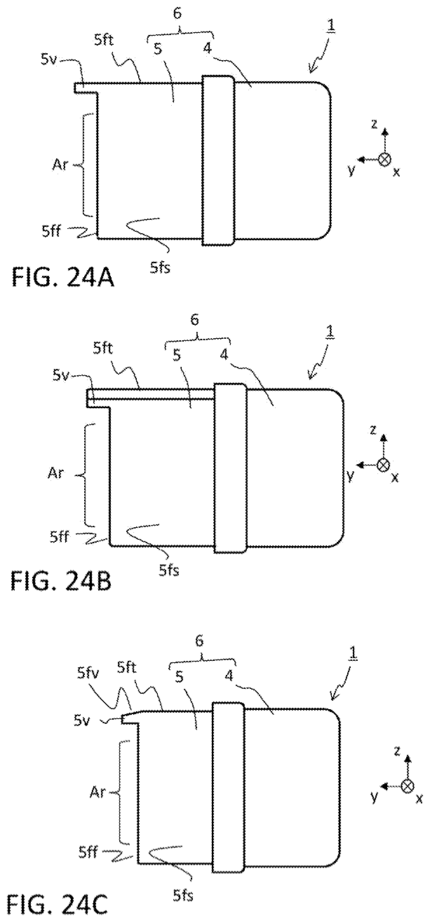

For example, as for Embodiment 2 and Embodiment 3, as shown in FIG. 23A and FIG. 23B, even if the front face 5ff is formed vertically, the top face 5ft, which is the characteristic part, is inclined with respect to the left-right direction or with respect to the front direction so as to exhibit an effect of suppressing the retention of water droplets. As for Embodiment 4, as shown in FIG. 24A to FIG. 24C, even if the front face 5ff is formed vertically, an effect of suppressing the retention of water droplets is exhibited by providing the visor 5v as the characteristic part.

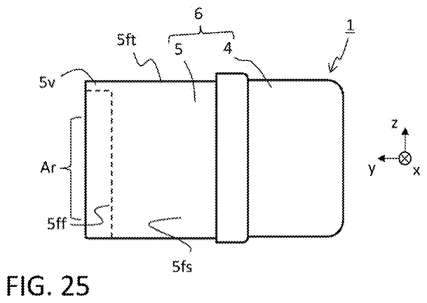

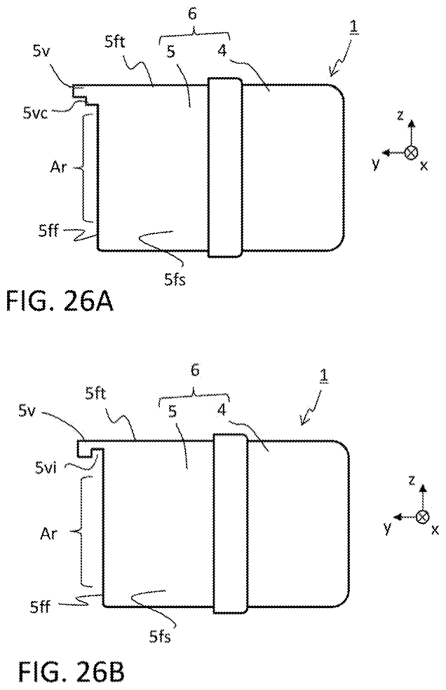

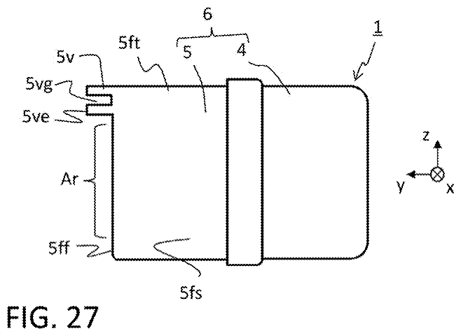

As for Embodiment 5, as shown in FIG. 25, even if the front face 5ff is formed vertically, an effect of suppressing the retention of water droplets is exhibited by providing the visor 5v surrounding the upper and both sides of the radio wave passing area Ar, as the characteristic part. As for Embodiment 6, as shown in FIG. 26A and FIG. 26B, even if the front face 5ff is formed vertically, the step 5vc or the cut-off groove 5vi is provided in the visor 5v as the characteristic part, thereby exhibiting an effect of suppressing the retention of water droplets. As for Embodiment 7, as shown in FIG. 27, even if the front face 5ff is formed vertically, an effect of suppressing the retention of water droplets is exhibited by providing the tip groove 5vg at the tip 5ve of the visor 5v as the characteristic part.

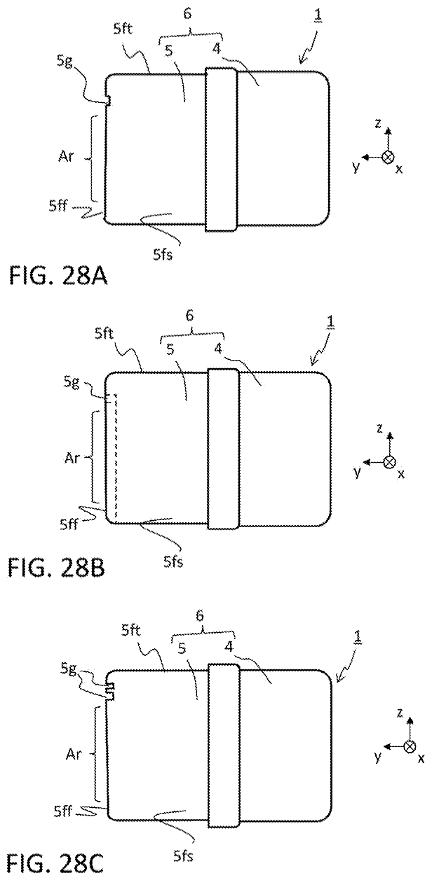

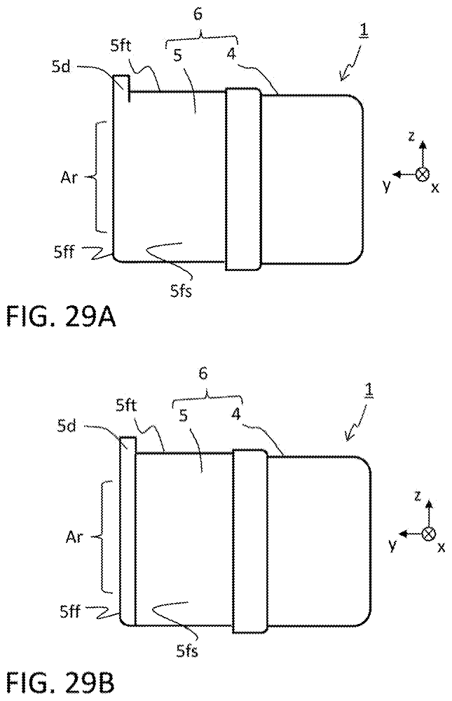

In Embodiment 8, as shown in FIG. 28A to FIG. 28C, even if the front face 5ff is formed vertically, an effect of suppressing the retention of water droplets is exhibited by providing the front groove 5g surrounding the upper side or the upper and both sides of the radio wave passing area Ar as the characteristic part. As for Embodiment 9, as shown in FIG. 29A and FIG. 29B, even if the front face 5ff is formed vertically, an effect of suppressing the retention of water droplets is exhibited by providing the bank 5d as the characteristic part.

As described above, according to the millimeter wave radar device 1 in each embodiment, the device is provided with the radio wave transmitter and receiver 2 formed with the transmitting and receiving surface 2fa for transmitting the millimeter waves to an outside and receiving reflected waves from the target, the controller 3 for controlling the operation of the radio wave transmitter and receiver 2 and for calculating at least either the positional relationship or the relative velocity in relation to the target on the basis of the output from the radio wave transmitter and receiver 2, and the waterproof housing 6 (case 4 and cover 5) for accommodating the radio wave transmitter and receiver 2 and the controller 3 and for holding the radio wave transmitter and receiver such that the normal line (Ln) of the transmitting and receiving surface 2fa is directed to the horizontal direction. And a front face 5ff positioned in the front direction in the transmission direction of the millimeter waves among outer faces of the housing 6 is configured to be rearwardly inclined to the downward direction at the portion assigned as the radio wave passing area Ar corresponding to the region in the vertical direction and the left-right direction of the transmitting and receiving surface 2fa, so that water droplets drop off from the portion assigned to the radio wave passing area Ar without being retained, and thus the attenuation by the water film can be suppressed even when the device is exposed to rain, thereby maintaining high detection accuracy.

When the inclination angle α of the inclination with respect to the vertical line is set within a range of 3° to 45°, it is possible to suppress the formation of the water film in the radio wave passing area Ar and to achieve compactness at the same time.

When the top face 5ft positioned on the upper side among the outer faces of the housing 6 is configured to be downwardly inclined from the center to the outer side in the left-right direction, the amount of water flowing from the top face 5ft to the front face 5ff can be reduced.

When the top face 5ft positioned on the upper side among the outer faces of the housing 6 is configured to be downwardly inclined toward the front face 5ff, the water flowing from the top face 5ft to the front face 5ff has momentum, the water separation at the front face 5ff is fine, and the formation of the water film can be further suppressed.

In the top face 5ft positioned on the upper side among the outer faces of the housing 6, the visor 5v projecting forward further from the front face 5ff extends over a region covering all the radio wave passing area Ar in the left-right direction, so that water droplets flowing forward from the top face 5ft can be dropped into the air without touching the front face 5ff. Furthermore, at least part of water droplets falling from the upper side toward the front face 5ff can be blocked.

When the recessed step 5vc or the groove (cut-off groove 5vi) is formed along the extending direction of the visor 5v on the face (inner face) of the visor 5v on the side close to the radio wave passing area Ar, water droplets that is to come around the front face 5ff side through the visor 5v can be dropped off before reaching the front face 5ff.

When the groove (tip groove 5vg) is formed on the tip 5ve of the visor 5v along the extending direction of the visor 5v, water droplets can be sucked into the tip groove 5vg at the tip 5ve of the visor 5v, moved along the tip groove 5vg to the region outside the radio wave passing area Ar, and then discharged.

In the both side faces positioned on the outer sides in the left-right direction, when the visor 5v extends over a portion positioned further below the radio wave passing area Ar, the side faces being among the outer faces of the housing 6, it is possible to prevent water droplets passing through the side faces 5fs from entering into the front face 5ff side. At this time, since the step 5vc, the cut-off groove 5vi, and the tip groove 5vg are also formed up to the same position, it is possible to further prevent water droplet from entering into the radio wave passing area Ar by guiding water droplets to the lower side of the radio wave passing area Ar.

When the front face 5ff has the front groove 5g that is formed above the radio wave passing area Ar and extends over the region covering all the radio wave passing area Ar in the left-right direction, the front groove 5g being opened in the front direction, even if water droplets come around the front face 5ff from the top face 5ft side, water droplets can be sucked into the front groove 5g, moved along the front groove 5g to the region outside the radio wave passing area Ar, and then discharged.

When the front groove 5g is formed over the portion positioned further below the radio wave passing area Ar via both outer sides to the radio wave passing area Ar in the left-right direction, water droplets that come around not only from the top face 5ft but also from the side face 5fs are prevented from entering into the radio wave passing area Ar and moved to the position (lower side) where they cannot return to the radio wave passing area Ar, and then discharged.

When the plurality of front grooves 5g are formed at intervals, multiple protection against water droplets can be achieved.

On the side close to the front face 5ff in the top face 5ft positioned on the upper side, the top face being among the outer faces of the housing 6, when the bank 5d projecting upward is configured to extend over the region covering all the radio wave passing area Ar in the left-right direction, water droplets received by the top face 5ft can be prevented from moving toward the front face 5ff and can be released to the side faces 5fs.

On the sides close to the front face 5ff in both side faces 5fs that are positioned in the outer sides in the left-right direction, the side faces being among the outer faces of the housing 6, when the bank 5d is configured to extend over the portion positioned further below the radio wave passing area Ar, water droplets can be prevented from coming around the front face 5ff from the side faces 5fs.

### DESCRIPTION OF REFERENCE NUMERALS AND SIGNS

1: millimeter wave radar device, 2: radio wave transmitter and receiver, 2a: antenna, 2fa: transmitting and receiving surface, 3: controller, 4: case, 5: cover, 5d: bank, 5fb: bottom face, 5ff front face, 5fs: side face, 5ft: top face, 5g: front groove, 5v: visor, 5vc: step, 5ve: tip, 5vg: tip groove, 5vi: cut-off groove, 6: housing, Ar: radio wave passing area, Ln: normal line, a: inclination angle.

1. A millimeter wave radar device, comprising:
a radio wave transmitter and receiver formed with a transmitting and receiving surface for transmitting millimeter waves to an outside and receiving reflected waves from a target in the outside;
a controller to control operation of the radio wave transmitter and receiver; and
a waterproof housing to accommodate the radio wave transmitter and receiver and the controller and to hold the radio wave transmitter and receiver such that a normal line of the transmitting and receiving surface is directed to a horizontal direction, wherein
a front face positioned in a front direction in a transmission direction of the millimeter waves among outer faces of the housing is rearwardly inclined to a downward direction at a portion assigned as a radio wave passing area corresponding to a region in a vertical direction and a left-right direction of the transmitting and receiving surface.

2. The millimeter wave radar device according to claim 1, wherein an inclination angle of the inclination with respect to a vertical line is 3° to 45°.

3. A millimeter wave radar device, comprising:
a radio wave transmitter and receiver formed with a transmitting and receiving surface for transmitting millimeter waves to an outside and receiving reflected waves from an external target;
a controller to control operation of the radio wave transmitter and receiver; and
a waterproof housing to accommodate the radio wave transmitter and receiver and the controller and to hold the radio wave transmitter and receiver such that a normal line of the transmitting and receiving surface is directed to a horizontal direction, wherein
a front face positioned in a front direction in a transmission direction of millimeter waves among outer faces of the housing includes a radio wave passing area corresponding to a region in a vertical direction and a left-right direction of the transmitting and receiving surface, and a portion of a top face that is positioned on an upper side and is close to the front face is downwardly inclined to an outward direction from a center in the left-right direction.

4. A millimeter wave radar device, comprising:
a radio wave transmitter and receiver formed with a transmitting and receiving surface for transmitting millimeter waves to an outside and receiving reflected waves from an external target;
a controller to control operation of the radio wave transmitter and receiver; and
a waterproof housing to accommodate the radio wave transmitter and receiver and the controller and to hold the radio wave transmitter and receiver such that a normal line of the transmitting and receiving surface is directed to a horizontal direction, wherein
a front face positioned in a front direction in a transmission direction of millimeter waves among outer faces of the housing includes a radio wave passing area corresponding to a region in a vertical direction and a left-right direction of the transmitting and receiving surface, and a portion of a top face that is positioned on an upper side and is close to the front face is downwardly inclined to the front face.

5. A millimeter wave radar device, comprising:
a radio wave transmitter and receiver formed with a transmitting and receiving surface for transmitting millimeter waves to an outside and receiving reflected waves from an external target;
a controller to control operation of the radio wave transmitter and receiver; and
a waterproof housing to accommodate the radio wave transmitter and receiver and the controller and to hold the radio wave transmitter and receiver such that a normal line of the transmitting and receiving surface is directed to a horizontal direction, wherein
a front face positioned in a front direction in a transmission direction of millimeter waves among outer faces of the housing includes a radio wave passing area corresponding to a region in a vertical direction and a left-right direction of the transmitting and receiving surface, and a visor projecting toward the front direction further from the front face extends over a region covering all the radio wave passing region in the left-right direction in a top face positioned on an upper side.

6. The millimeter wave radar device according to claim 5, wherein a step or a groove is formed along an extending direction of the visor on a face of the visor close to the radio wave passing area.

7. The millimeter wave radar device according to claim 5, wherein a groove is formed in a tip of the visor along the extending direction of the visor.

8. The millimeter wave radar device according to claim 5, wherein, in both side faces positioned on outer sides in the left-right direction, the side faces being among the outer faces of the housing, the visor extends over a portion positioned further below the radio wave passing area.

9. A millimeter wave radar device, comprising:
a radio wave transmitter and receiver formed with a transmitting and receiving surface for transmitting millimeter waves to an outside and receiving reflected waves from an external target;
a controller to control operation of the radio wave transmitter and receiver; and
a waterproof housing to accommodate the radio wave transmitter and receiver and the controller and to hold the radio wave transmitter and receiver such that a normal line of the transmitting and receiving surface is directed to a horizontal direction, wherein
a front face positioned in a front direction in a transmission direction of millimeter waves among outer faces of the housing includes a radio wave passing area corresponding to a region in a vertical direction and a left-right direction of the transmitting and receiving surface, and at least one front groove opened in the front direction is formed to extend over a region covering all the radio wave passing area in the left-right direction above the radio wave passing area.

10. The millimeter wave radar device according to claim 9, wherein the at least one front groove is formed to extend over a portion positioned further below the radio wave passing area via both outer sides of the radio wave passing area in the left-right direction.

11. The millimeter wave radar device according to claim 9, wherein
the at least one front groove comprises a plurality of front grooves formed at intervals.

12. A millimeter wave radar device, comprising:
a radio wave transmitter and receiver formed with a transmitting and receiving surface for transmitting millimeter waves to an outside and receiving reflected waves from an external target;
a controller to control operation of the radio wave transmitter and receiver; and
a waterproof housing to accommodate the radio wave transmitter and receiver and the controller and to hold the radio wave transmitter and receiver such that a normal line of the transmitting and receiving surface is directed to a horizontal direction, wherein
a front face positioned in a front direction in a transmission direction of millimeter waves among outer faces of the housing includes a radio wave passing area corresponding to a region in a vertical direction and a left-right direction of the transmitting and receiving surface, a bank projecting upward extends over a region covering all the radio wave passing area in the left-right direction in a portion of a top face that is positioned on an upper side and is close to the front face.

13. The millimeter wave radar device according to claim 12, wherein, on sides close to the front face in both side faces that are positioned on outer sides in the left-right direction, the side faces being among the outer faces of the housing, the bank extends over a portion positioned further below the radio wave passing area.

14. (canceled)

15. (canceled)

16. The millimeter wave radar device according to claim 10, wherein the at least one front groove comprises a plurality of front grooves formed at intervals.

17. The millimeter wave radar device according to claim 9, wherein a portion of the front face assigned to the radio wave passing area is rearwardly inclined to a downward direction.

18. The millimeter wave radar device according to claim 10, wherein a portion of the front face assigned to the radio wave passing area is rearwardly inclined to a downward direction.

19. The millimeter wave radar device according to claim 11, wherein a portion of the front face assigned to the radio wave passing area is rearwardly inclined to a downward direction.

20. The millimeter wave radar device according to claim 17, wherein an inclination angle of the inclination with respect to a vertical line is 3° to 45°.

21. The millimeter wave radar device according to claim 18, wherein an inclination angle of the inclination with respect to a vertical line is 3° to 45°.

22. The millimeter wave radar device according to claim 19, wherein an inclination angle of the inclination with respect to a vertical line is 3° to 45°.
